(19) United States
(12) Patent Application Publication
(10) Pub. No.: US 2022/0161258 A1
(43) Pub. Date: May 26, 2022

(54) BIOPROCESS FILTRATION EXPERIMENT SYSTEM

(71) Applicant: Sartorius Stedim Biotech GmbH, Goettingen (DE)

(72) Inventors: Stefan Obermann, Erbsen (DE); Dennis Groesche, Goettingen (DE); Fabian Walter, Northeim (DE); Christian Lock, Friedland (DE); Hendrik Rosenberg, Goettingen (DE); Martin Lohrberg, Ebergoetzen (DE); Roman Ritzka, Obernfeld (DE)

(21) Appl. No.: 17/534,108

(22) Filed: Nov. 23, 2021

(30) Foreign Application Priority Data
Nov. 24, 2020 (EP) 20 209 610.3

(51) Int. Cl. B01L 3/00; G01N 1/22

(52) U.S. Cl. CPC B01L 3/502753; B01L 3/502715; B01L 3/502738; G01N 1/2205; B01L 2200/12; B01L 2400/06; B01L 2300/0663; B01L 2300/0681; B01L 2300/087; B01L 2200/0684; B01L 2400/0478; B01L 2200/16

(57) ABSTRACT

A bioprocessing filtration experiment system for filtering a liquid test medium as part of a filtration experiment in a filtration experiment section of the filtration experiment system, which filtration experiment section runs from a receptacle for holding the test medium to be filtered to a fluid outlet for the filtered test medium, wherein the filtration experiment system is designed to ascertain, as part of the filtration experiment, sensor data as experiment data for at least one filter, said experiment data being able to be taken as a basis for selecting and/or dimensioning the filter of a target system according to predetermined scaling criteria. It is proposed that the filtration experiment system can be preassembled on an at least partially programming-related and/or circuit-related, at least partially fluidics-related and/or at least partially sensor-related basis.

### CLAIM OF PRIORITY

This application claims the benefit of European Patent Application No. EP 20 209 610.3 filed on Nov. 24, 2020, the disclosure of which is incorporated herein by reference in its entirety.

### FIELD OF THE TECHNOLOGY

Various embodiments relate to a bioprocessing, in particular biopharmaceutical, filtration experiment system, to a data receiving instrument for use in such a bioprocessing filtration experiment system and to the use of a packed filtration experiment set comprising preassembled installation components for setting up such a bioprocessing filtration experiment system.

### BACKGROUND

A bioprocessing filtration experiment system is generally understood to mean a system that is used to perform filtration experiments with a liquid, for example biological, in particular biopharmaceutical, test medium on a small scale. Various objectives are conceivable here. A filtration experiment system can quite generally be used to capture the flow as a function of pressure, to measure behavior for different wetting media as a pretreatment, to determine service life (time before blockage) or the like. A filtration experiment system can also be used to find suitable filters for a filtration on a large scale, for example for an industrial production of biopharmaceuticals. By way of example, a filtration experiment produces experiment data, namely sensor data from for example pressure sensors, for at least one filter or at least one combination of filter and wetting medium, said experiment data being able to be taken as a basis for selecting and/or dimensioning the filter and/or the wetting medium of a target system according to predetermined scaling criteria. In particular, such a filtration experiment system can be used to select the optimum filter size or filter surface for a specific filtration process, possibly with an optimum wetting medium therefor.

An applicable filtration experiment involves a predefined amount of the test medium being filtered using a filter of a predefined size, possibly by applying a specific wetting medium, with the pressure and volume flow of the test medium being captured by sensor and documented when it passes through the filtration experiment section. For this, one variable, for example pressure, is kept constant in each case and the other variable, for example volume flow, is measured

The known filtration experiment systems fundamentally require the user to connect a multiplicity of components, in particular sensors and filters, to one another mechanically and fluidically. The sensors also need to be electrically connected to an applicable data receiving instrument. Furthermore, a drive for the liquid test medium, for example a pump or a supply line for providing compressed air, in particular together with a pneumatic pressure regulator, needs to be fluidically and possibly electrically connected. If necessary, there may also be provision for a drive for air for draining the fluid lines of the filtration experiment system, for example a pump or a supply line for providing compressed air, in particular also with a pneumatic pressure regulator, this likewise requiring a fluidic and possibly electrical connection to be made. The term “pump” is intended to be understood broadly in the present case and covers machines for conveying not only liquids (hydraulic pumps, e.g., hose pumps) but also gases (pneumatic pumps, e.g. compressors).

The individual mechanical, electrical and fluidic connections for every filtration experiment are made manually.

### SUMMARY

Various aspects are based on the problem of configuring and developing the known bioprocessing filtration experiment system in such a way that the handling thereof is simplified.

The above problem is solved for a bioprocessing, in particular biopharmaceutical, filtration experiment system according to the disclosure.

The important fundamental consideration is that of preassembling at least individual component parts of the filtration experiment system in order to reduce the number of work steps to be carried out by the user when planning and setting up the system. This can be accomplished by programming-related and/or circuit-related preassembly, that is to say preassembly of software required for a certain filtration experiment and/or of an electrical circuit, in particular integrated circuit, required therefor. Additionally or alternatively, there may also be provision for fluidics-related preassembly, that is to say preassembly of parts through which the test medium can flow, such as filters, valves and/or line sections. Additionally or alternatively, there may also be provision for sensor-related preassembly, that is to say preassembly concerning the sensors of the filtration experiment system.

Preassembly means that multiple instances of the aforementioned parts, such as filters, valves, sensors, fluid lines or the like, have already been selected in a manner specific to an experiment, that is to say in a manner appropriate to a certain filtration experiment, and preassembled, in particular by the manufacturer, to form a unit. Such a preassembled unit is also referred to as an assembly module below. Concerning the software and/or electrical circuit, preassembly means that the software or electrical circuit for a certain filtration experiment has been provided in a manner specific to the experiment. This significantly simplifies the planning and setup of the filtration experiment system.

Specifically, it is proposed that the filtration experiment system is preassembled on an at least partially programming-related and/or circuit-related, at least partially fluidics-related and/or at least partially sensor-related basis.

Various embodiments include components and parts of the filtration experiment system and in particular of the filtration experiment section. In the present case, the filtration experiment section is defined as that section of the filtration experiment system through which the test medium flows, starting at the receptacle through to the outlet. Various components are in particular a valve arrangement, a sensor arrangement, a filter arrangement, a fluid line network, a data receiving instrument and/or a weighing arrangement. Various parts are accordingly valves, sensors, filters and line sections.

Various embodiments relate to the preassembly of at least one data receiving instrument. A data receiving instrument is a device that is designed at least to receive sensor data from the sensor arrangement. These are for example data from one or more pressure sensors, volume flow sensors, conductivity sensors, optical sensors, e.g. turbidity sensors, UV sensors, infrared and/or Raman sensors, temperature sensors, etc. The data receiving instrument may also be designed to process the sensor data and/or, as a control unit, to control a pump and/or a pneumatic pressure regulator of the filtration experiment system or of one or more valves of the valve arrangement. Applicable control is in particular carried out on the basis of control data that, at least in some cases, are produced by the processing of the sensor data. That is to say that the respective control then takes place on the basis of the sensor data. The respective data receiving instrument is in particular preassembled on a programming-related and/or circuit-related basis concerning said reception of sensor data, the processing of the sensor data and/or the control of the pump and/or of the pneumatic pressure regulator and/or of the respective valve. The respective software and/or electrical circuit of the data receiving instrument is thus matched to a certain filtration experiment type (e.g. “constant pressure” or “constant flow”) or even filtration experiment, or prepared for a certain filtration experiment.

It will once again be emphasized that, here and below, the term “pump” is intended to be understood broadly and covers machines for conveying not only liquids, called “hydraulic pumps” (e.g. hose pumps) below, but also gases, called “pneumatic pumps” (e.g. compressors) below. As such, a pump for the filtration experiment system as proposed may be intended as a drive for the liquid test medium and/or as a drive for air, for example for draining the fluid lines of the filtration experiment system as proposed. However, the drive for the liquid test medium and/or the drive for air may also be an external compressed air source, in particular an external compressed air network, an external compressed air canister or the like, possibly with the fluidic interposition of a pneumatic pressure regulator for regulating the external compressed air source.

Some embodiments include preassemblies of the filtration experiment system.

As such, one configuration relates to the preassembly of the filtration experiment system by virtue of the measurement principle, the specifications and/or the installation position of at least one sensor being matched to a certain filtration experiment, or prepared for a certain filtration experiment. Such preassembly is sensor-related preassembly.

Various embodiments relate to the preassembly of the filtration experiment system by virtue of the operating principle, the specifications and/or the installation position of at least one filter being matched to a certain filtration experiment, or prepared for a certain filtration experiment. Such preassembly is fluidics-related preassembly.

Various embodiments relate to the preassembly of the filtration experiment system by virtue of the type of actuation, the specifications and/or the installation position of at least one valve being matched to a certain filtration experiment, or prepared for a certain filtration experiment. Such preassembly is likewise fluidics-related preassembly.

Various embodiments relate to the preassembly of the filtration experiment system by virtue of the specifications and/or the installation position of at least one line section being matched to a certain filtration experiment, or prepared for a certain filtration experiment. Such preassembly is likewise fluidics-related preassembly.

In various embodiments, fluidics-related and/or sensor-related preassembly results from one or more assembly modules, that is to say preassembled units of parts of the filtration experiment system, in particular of the filtration experiment section. The use of such assembly modules simplifies assembly and hence startup, but also disassembly, for example for transportation purposes. The respective assembly module comprises at least one or more line sections of the fluid line network and at least one other of the parts “sensor”, “filter” and “valve”. An assembly module is also conceivable that comprises a receptacle in addition to one of the parts “sensor”, “filter”, “valve” and “line section”. The selection of the parts that are preassembled to form the assembly module then matches a certain filtration experiment. In this case, it is conceivable for just a single assembly module to form the filtration experiment section. However, it is also conceivable for the single assembly module also to be compiled using another of the parts “sensor”, “filter”, “valve” and “line section” and, in some embodiments, using another assembly module defined as previously, so as then to form the filtration experiment section together.

An assembly module may already have been formed by virtue of one of the parts “sensor”, “filter”, “valve” and “receptacle” having been connected to a line section of the fluid line network as intended. Here and below, “as intended” means a connection completed as per the intended purpose. Various embodiments, such an assembly module comprises at least two of the parts “sensor”, “filter”, “valve” and “receptacle” in addition to said line section, which means that for example a receptacle and a sensor and/or two sensors are each connected to one another by way of a line section as intended.

According to one variant, the respective parts connected to one another as intended are fixed in relation to one another solely by a line section, that is to say without using a separate supporting structure to which the respective part is attached. In this case, the respective assembly module can be a single-use component, that is to say a disposable component. When the single-use components are swapped as appropriate, there is no need to clean the parts and there is no risk of contamination in two successive filtration experiments with different test media.

According to another variant, however, it is also conceivable for multiple instances of the parts “sensor”, “filter”, “valve” and “line section” of an assembly module to be fixed in relation to one another by way of a common supporting structure in the form of a housing, in particular a plastic, resin, glass, ceramic and/or metal housing. In this case too, it is conceivable to produce one or more of these parts as single-use components, in particular the filter(s).

The assembly modules described, both the assembly modules without a supporting structure and those having a housing, are in particular produced in such a way that multiple assembly modules of identical design and/or assembly modules of different design can be connected to one another mechanically, pneumatically, hydraulically and/or electrically by way of in each case at least one applicable interface. If the assembly modules have a supporting structure or a housing, they can in particular be vertically stacked above one another.

In various embodiments, the filtration experiment system has a support to which the respective receptacle and/or one or more sensors, valves and/or assembly modules are fixable or fixed.

The support may be a stand, in particular a bar-like or plate-like stand, having an, in particular adjustable-height, holder. However, it is also conceivable for the support to be a mounting plate, in particular attached to a stand, for example a bar-like or plate-like stand, to which mounting plate the respective receptacle and/or the respective sensor and/or the respective assembly module is fixable or fixed.

Fixing in the latter case can be effected magnetically. For magnetic fixing, the respective part, for example the respective receptacle and/or the respective sensor, can have an attachment section having a magnet, the mounting plate being of magnetic configuration, in particular made of metal, at least at the points intended for attaching the respective sensor or as a whole. In principle, it is also conceivable for there to be provision for a magnet on the mounting plate at least at the points intended for attaching the respective sensor, in which case the sensor then has a magnetic attachment section, in particular made of metal. Additionally or alternatively, there may also be provision for form-fit and/or force-fit fixing, however. Such fixing can be effected for example by means of a clamp or plug-in connection between the respective sensor and the mounting plate.

The mounting plate can be part of a housing of a data receiving instrument as defined previously, in particular of the data receiving instrument that is designed to carry out bundling of the sensor data to form data packets and sending of the data packets and/or conversion of analog sensor data into digital sensor data and/or, in particular prior to the conversion, amplification of the analog sensor signals as processing of the sensor data. The bundling of the sensor data to form data packets results in there being fewer data cables, such as only a single data cable, for transmitting sensor data to the control unit, which simplifies handling of the filtration experiment system.

Various embodiments provide that the respective support and/or the respective stand may be mechanically connected to the housing of a balance of the weighing arrangement.

In accordance with some embodiments, a data receiving instrument for use in a bioprocessing, in particular biopharmaceutical, filtration experiment system for filtering a liquid test medium as part of a filtration experiment in a filtration experiment section of the filtration experiment system, which filtration experiment section runs from a receptacle for holding the test medium to be filtered to an outlet for the filtered test medium, is provided. The data receiving instrument is designed to receive, in particular also to capture and/or process, sensor data, produced as part of the filtration experiment, from a sensor arrangement as experiment data for at least one filter, said experiment data being able to be taken as a basis for selecting and/or dimensioning the filter of a target system according to predetermined scaling criteria. In this respect, reference can be made to the explanations pertaining to the bioprocessing filtration experiment system as proposed.

The essential aspect of the data receiving instrument as proposed is that it is preassembled on a programming-related and/or circuit-related basis concerning the reception of sensor data from the sensor arrangement.

In various embodiments, according to which the data receiving instrument can automatically detect the experiment start and/or the experiment end of a filtration experiment. This can result from a volume flow sensor being activated to accompany the beginning of a flow at the start of the experiment or deactivated to accompany the stopping of the flow at the end of the experiment.

In various embodiments, the use of a packed filtration experiment set comprising preassembled system components for setting up a bioprocessing, in particular biopharmaceutical, filtration experiment system as proposed is provided. In this respect, reference can be made to the explanations pertaining to the bioprocessing filtration experiment system as proposed.

The essential aspect of the use as proposed is that the filtration experiment set in the pack comprises at least one assembly module comprising at least one line section of the fluid line network, which line section is connected to at least one sensor of the sensor arrangement, to at least one filter of the filter arrangement and/or to at least one valve of the valve arrangement as intended. There may also be provision for a receptacle, which can be fluidically connected to the line section, as part of the assembly module. To assemble the bioprocessing filtration experiment system, the filtration experiment set is unpacked, that is to say removed from the packaging, and mechanically, fluidically and/or electrically connected to other installation system components.

Some embodiments provide a bioprocessing, in particular biopharmaceutical, filtration experiment system for filtering a liquid test medium as part of a filtration experiment in a filtration experiment section of the filtration experiment system, which filtration experiment section runs from a receptacle for holding the test medium to be filtered to a fluid outlet for the filtered test medium, wherein the filtration experiment system is designed to ascertain, as part of the filtration experiment, sensor data as experiment data for at least one filter, said experiment data being able to be taken as a basis for selecting and/or dimensioning the filter of a target system according to predetermined scaling criteria, wherein the filtration experiment system is preassembled on an at least partially programming-related and/or circuit-related, at least partially fluidics-related and/or at least partially sensor-related basis.

In some embodiments, the filtration experiment system, in particular the filtration experiment section, comprises a valve arrangement containing one or more valves, a sensor arrangement containing one or more sensors, in particular one or more pressure sensors, volume flow sensors and/or temperature sensors, a filter arrangement containing one or more filters, in particular one or more liquid filters and/or air filters, and/or a fluid line network containing multiple line sections via which the test medium reaches the respective filter, and/or wherein the filtration experiment system comprises at least one data receiving instrument for receiving sensor data from the sensor arrangement and/or comprises a weighing arrangement containing a balance.

In some embodiments, at least one data receiving instrument is preassembled on a programming-related and/or circuit-related basis concerning the reception of sensor data from the sensor arrangement, and/or wherein at least one data receiving instrument is preassembled on a programming-related and/or circuit-related basis concerning the capture and/or processing of sensor data from the sensor arrangement, and, in some embodiments, wherein the processing of the sensor data includes comparing sensor data with at least one setpoint value or setpoint value range and/or bundling sensor data to form data packets and sending the data packets and/or converting analog sensor data into digital sensor data and/or, in particular prior to the conversion, amplifying the analog sensor signals.

In some embodiments, the filtration experiment system comprises at least one pump, in particular a hydraulic pump and/or pneumatic pump, and/or at least one pneumatic pressure regulator and wherein at least one data receiving instrument is preassembled on a programming-related and/or circuit-related basis concerning the control of the pump and/or of the pneumatic pressure regulator. In some embodiments, the pump and/or the pneumatic pressure regulator is controllable in such a way that it is possible to produce a predefined, constant or varying, pressure or volume flow of the test medium in the filtration experiment section and/or a defined, constant or varying, pressure or volume flow of a wetting liquid, in particular in the case of an automatic filter wetting process, in the filtration experiment section and/or a defined, constant or varying, pressure or volume flow of the compressed air and/or of a flushing liquid, in particular in the case of an automatic draining and/or flushing process, in the filtration experiment section.

In some embodiments, at least one data receiving instrument is preassembled on a programming-related and/or circuit-related basis concerning the control of at least one valve of the valve arrangement, in particular concerning the control for a filter wetting process, for a filter venting process, for a filtration experiment with the test medium and/or for a draining and/or flushing process.

In some embodiments, the at least one data receiving instrument comprises a power supply, at least one data interface, a memory for storing raw sensor data and/or processed sensor data, a pneumatic inlet, at least one pneumatic outlet, a pneumatic pressure regulator and/or at least one pneumatic pump. In some embodiments, the respective data receiving instrument is free of hydraulic connections and is in particular arrangeable or arranged at a physical distance from the filtration experiment section.

In some embodiments, the filtration experiment system, in particular the filtration experiment section and/or the sensor arrangement, is preassembled on a sensor-related basis concerning the measurement principle, the specifications and/or the installation position of at least one sensor of the sensor arrangement, and/or wherein the filtration experiment system, in particular the filtration experiment section and/or the filter arrangement, is preassembled on a fluidics-related basis concerning the operating principle, the specifications and/or the installation position of at least one filter of the filter arrangement, and/or wherein the filtration experiment system, in particular the filtration experiment section and/or the valve arrangement, is preassembled on a fluidics-related basis concerning the type of actuation, the specifications and/or the installation position of at least one valve of the valve arrangement, and/or wherein the filtration experiment system, in particular the filtration experiment section and/or the fluid line network, are/is preassembled on a fluidics-related basis concerning the specifications and/or the installation position of at least one line section of the fluid line network.

In some embodiments, at least one sensor of the sensor arrangement, at least one filter of the filter arrangement, at least one valve of the valve arrangement and/or at least one receptacle together with at least one line section of the fluid line network form an assembly module preassembled on a fluidics-related and/or sensor-related basis, the assembly module or multiple such assembly modules in particular forming the filtration experiment section. In some embodiments, the respective assembly module comprises the receptacle for the test medium and/or a receptacle for wetting liquid and/or flushing liquid, and/or wherein at least one assembly module comprises a fluid outlet for discharging the filtered test medium into a collecting container of the filtration experiment system.

In some embodiments, the respective assembly module comprises a housing, in particular a plastic, resin, glass, ceramic and/or metal housing, for holding at least one sensor of the sensor arrangement, at least one filter of the filter arrangement, at least one valve of the valve arrangement and/or at least one line section of the fluid line network. In some embodiments at least one sensor, valve and/or line section is arranged or arrangeable inside the housing and/or at least one filter is arranged or arrangeable, in particular detachably, outside the housing.

In some embodiments, an assembly module is free of filters and/or comprises electronics having at least one electrical circuit board, in particular having an integrated circuit, for receiving sensor data and/or for controlling at least one valve and/or for controlling a pump, in particular a hydraulic pump and/or pneumatic pump, and/or wherein an assembly module comprises a pump, in particular a hydraulic pump and/or pneumatic pump. In some embodiments, the electronics and/or electrical circuit board and/or the pump are arranged in or on the housing of the assembly module.

In some embodiments, every assembly module on which a filter is arrangeable or arranged, in particular every housing to or in which a filter is attachable or attached, has precisely one associated filter.

In some embodiments, the respective assembly module, in particular the housing, comprises at least one pneumatic interface, at least one hydraulic interface and/or at least one electrical interface, wherein each pair of assembly modules, in particular each pair of housings, is directly mechanically connectable or connected to one another and is in particular vertically stackable or stacked above one another.

In some embodiments, a mechanical connection, in particular direct mechanical connection, of two assembly modules to one another forms at least one pneumatic connection, at least one hydraulic connection and/or at least one electrical connection between the assembly modules by way of each pair of mutually corresponding interfaces.

In some embodiments, the filtration experiment system has a support and wherein only one receptacle, in particular only the receptacle for the test medium and/or only the receptacle for wetting liquid and/or flushing liquid, is fixable or fixed to the support and/or only one or more sensors of the sensor arrangement are each fixable or fixed to the common support and/or only one or more assembly modules are each fixable or fixed to the common support. In some embodiments, the support is a stand having a, in particular adjustable-height, holder, or wherein the support is a mounting plate, in particular attached to a stand, to which one or more sensors of the sensor arrangement, the receptacle and/or one or more assembly modules are each, in particular detachably, fixable or fixed. In some embodiments, the respective sensor, receptacle and/or assembly module is fixed to the mounting plate magnetically, with a form-fit and/or with a force-fit.

In some embodiments, in the mounted state, each pair of sensors fixed to the mounting plate has a filter arranged between them that is itself not fixed to the mounting plate.

In some embodiments, the mounting plate is part of a housing of a data receiving instrument, in particular the data receiving instrument that is designed to carry out bundling of the sensor data to form data packets and sending of the data packets and/or conversion of analog sensor data into digital sensor data and/or, in particular prior to the conversion, amplification of the analog sensor signals as processing of the sensor data.

In some embodiments, the respective support and/or the respective stand is mechanically connected to the housing of a balance of the weighing arrangement.

Some embodiments provide a data receiving instrument for use in a bioprocessing, in particular biopharmaceutical, filtration experiment system for filtering a liquid test medium as part of a filtration experiment in a filtration experiment section of the filtration experiment system, which filtration experiment section runs from a receptacle for holding the test medium to be filtered to a fluid outlet for the filtered test medium, in particular for use in a filtration experiment system as described herein, wherein the data receiving instrument is designed to receive, in particular also to capture and/or process, sensor data, produced as part of the filtration experiment, from a sensor arrangement as experiment data for at least one filter, said experiment data being able to be taken as a basis for selecting and/or dimensioning the filter of a target system according to predetermined scaling criteria, wherein the data receiving instrument is preassembled on a programming-related and/or circuit-related basis concerning the reception of sensor data from the sensor arrangement.

In some embodiments, the data receiving instrument is designed to automatically detect the experiment start of a filtration experiment and to automatically start the recording of the sensor data and/or to automatically detect the experiment end of a filtration experiment and to automatically end the recording of the sensor data. In some embodiments, wherein when pressurization sets the test medium in motion at the start of an experiment, this activates a volume flow sensor and produces applicable sensor data, the data receiving instrument detecting the start of the experiment on the basis of these applicable sensor data, and/or wherein as soon as test medium no longer flows at the end of an experiment, this deactivates a volume flow sensor and produces applicable sensor data or no further sensor data, the data receiving instrument detecting the end of the experiment on the basis of these applicable sensor data or on the basis of the absence of further sensor data.

Various embodiments provide the use of a packed filtration experiment set comprising preassembled system components for setting up a bioprocessing, in particular biopharmaceutical, filtration experiment system as described herein, wherein the filtration experiment set in the pack comprises at least one assembly module comprising at least one line section of the fluid line network, which line section is connected to at least one sensor of the sensor arrangement, to at least one filter of the filter arrangement and/or to at least one valve of the valve arrangement as intended, and in particular a receptacle, which can be fluidically connected to the line section.

### BRIEF DESCRIPTION OF THE DRAWINGS

Various aspects are explained in more detail below with reference to a drawing that shows merely exemplary embodiments. In the drawing,

FIG. 1 shows a schematic perspective view of a bioprocessing filtration experiment system, as proposed, according to a first exemplary embodiment,

FIG. 2 shows a schematic perspective view of a bioprocessing filtration experiment system, as proposed, according to a second exemplary embodiment,

FIG. 3 shows a schematic perspective view of a bioprocessing filtration experiment system, as proposed, according to a third exemplary embodiment, and

FIG. 4 shows a schematic sectional view of the filtration experiment system shown in FIG. 3 in the assembled state (left) and during assembly (right).

### DETAILED DESCRIPTION

It should be pointed out beforehand that the drawing shows only the components of the bioprocessing, in particular biopharmaceutical, filtration experiment system 1 as proposed that are necessary to explain the teachings. Accordingly, good clarity has been achieved by dispensing with showing a plurality of additionally provided compressed air sources, power supply sources, valves, sensors or the like.

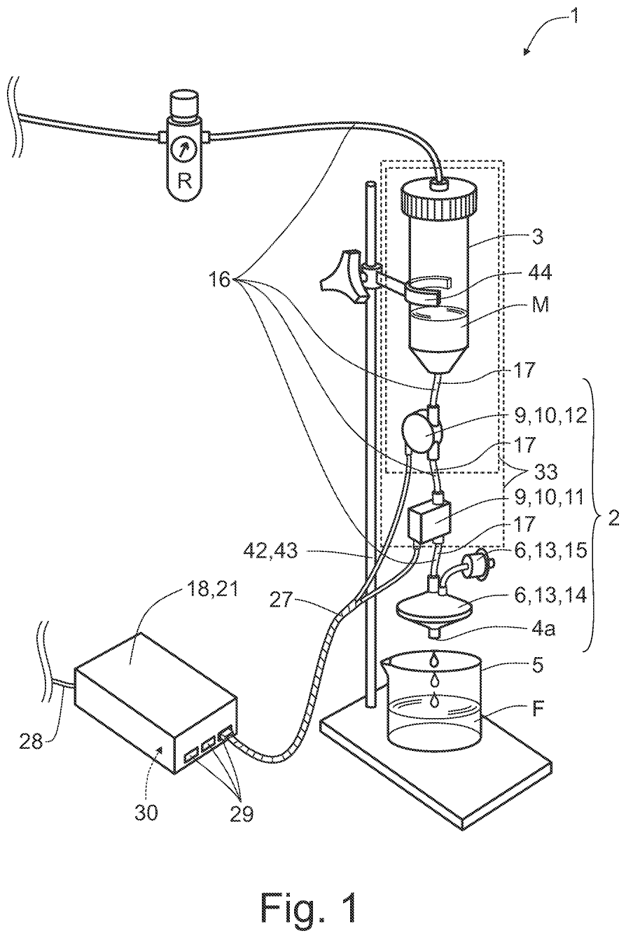

The filtration experiment systems 1 shown in each of FIGS. 1 to 4 are used for filtering a liquid, for example here biological, test medium M in a filtration experiment section 2 of the filtration experiment system 1. The filtration experiment section 2 runs from a receptacle 3 for holding the test medium to be filtered M to a fluid outlet 4a, from which the filtered test medium F (filtration) reaches a collecting container 5. The collecting container 5 is not counted as part of the filtration experiment section 2 here. The filtration experiment section 2 starts at the receptacle 3 then extends downstream and ends at the fluid outlet 4a. The filtration experiment system 1 is designed to ascertain, as part of a filtration experiment, sensor data as experiment data for at least one filter 6 of the filtration experiment section 2. The experiment data can then be taken as a basis for selecting and/or dimensioning, according to predetermined scaling criteria, an applicable filter of a target system for the respective filter 6 of the filtration experiment section 2 for which the experiment data have been ascertained.

The essential aspect is now that the filtration experiment system 1 is preassembled on an at least partially programming-related and/or circuit-related, at least partially fluidics-related and/or at least partially sensor-related basis. “Preassembled on a programming-related and/or circuit-related basis” means that a piece of software and/or an electrical circuit, in particular an integrated circuit, provided in the filtration experiment system 1 is configured in a manner specific to the experiment. “Preassembled on a fluidics-related basis” means that a unit comprising parts of the filtration experiment system 1, in particular of the filtration experiment section 2, through which there may be a fluidic, that is to say pneumatic and/or hydraulic, flow is configured in a manner specific to the experiment. “Preassembled on a sensor-related basis” means that the sensor system of the filtration experiment system 1 is configured in a manner specific to the experiment.

The filtration experiment system 1 explained here by way of illustration, in particular the filtration experiment sections 2, comprise, here, a valve arrangement 7 containing one or more valves 8, a sensor arrangement 9 containing one or more sensors 10, in particular one or more pressure sensors 11, volume flow sensors 12 (also called flow sensors) and/or temperature sensors, a filter arrangement 13 containing one or more filters 6, for example flat filters, in particular liquid filters 14 and/or air filters 15, for example of a vent valve, and/or a fluid line network 16 containing multiple line sections 17 via which the test medium M reaches the respective filter 6, 14. The liquid filters 14 here are the filters for which the experiment data are ascertained, whereas the air filters 15 that are possibly present are merely used as aids for wetting the respective liquid filter 14.

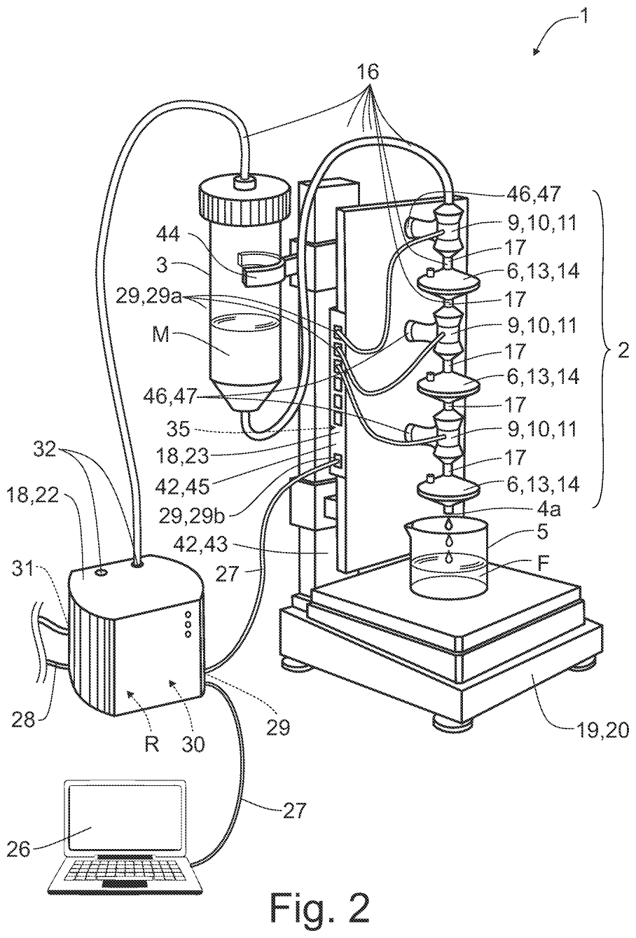

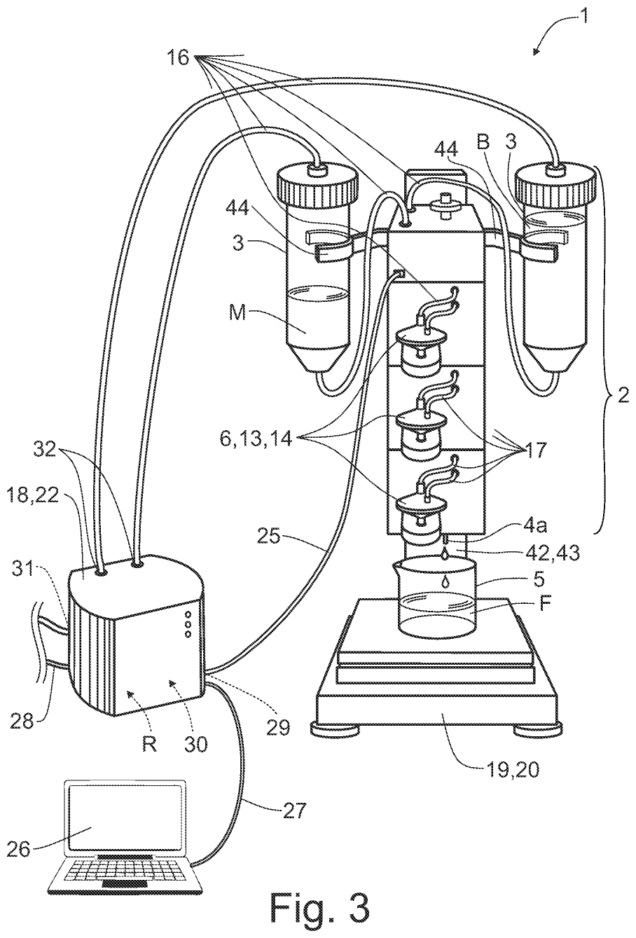

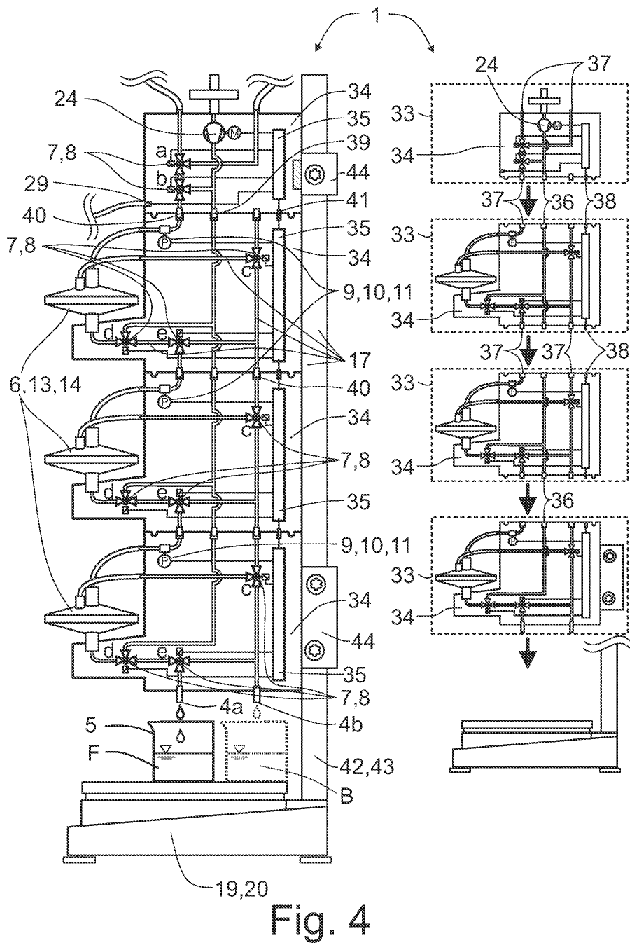

In the exemplary embodiment shown in FIG. 1, the sensors 10, 11, 12, the filters 6, 14, 15 and the line sections 17 can be single-use components. The same can apply at least to the filters 6, 14 in the exemplary embodiment shown in FIG. 2 and the exemplary embodiment shown in FIGS. 3 and 4. In a variant that is not shown here, the valves 8 may also be configured as single-use components. In the exemplary embodiment shown in FIG. 2, the line sections 17 are additionally also configured as single-use components, it can also be possible to dispense with line sections 17 between the sensor 9 and the filter 6. Finally, at least in the exemplary embodiment shown in FIG. 1, the receptacle(s) 3 can also be single-use components.

Additionally or alternatively, the filtration experiment system 1 has, here, as shown in the exemplary embodiments in FIGS. 1 to 4, at least one data receiving instrument 18 for receiving sensor data from the sensor arrangement 9.

Additionally or alternatively, the filtration experiment system 1 has, here, as shown in the exemplary embodiments in FIGS. 2 to 4, a weighing arrangement 19 having a balance 20.

There is provision for various types of data receiving instruments 18 in the exemplary embodiments.

As such, the data receiving instrument 18 in the exemplary embodiment in FIG. 1 is a device 21 that permits not only the reception of sensor data but also capture of the sensor data, that is to say recording of the sensor data. There is provision here neither for a user interface nor for the possibility of controlling valves or a pump or a pneumatic pressure regulator. However, the data receiving instrument 18 in the form of the device 21 is, here, designed to automatically detect the experiment start of a filtration experiment and to automatically start the recording of the sensor data and/or to automatically detect the experiment end of a filtration experiment and to automatically end the recording of the sensor data. By way of example, pressurization here sets the test medium M in motion, as a result of which the volume flow sensor 12 is activated, in particular a measurement wheel (impeller) of the volume flow sensor 12 begins to rotate, and the data receiving instrument 18 detects the start of the experiment on the basis of the applicable sensor data. Conversely, the volume flow sensor 12 is deactivated, or the measurement wheel of the volume flow sensor 12 stops rotating, as soon as no further test medium M flows through it, the data receiving instrument 18 then detecting the end of the experiment on the basis of the applicable sensor data or an absence of further sensor data.

In order to route the test medium M under pressure through the filtration experiment section 2, the exemplary embodiment shown in FIG. 1, as well as the other exemplary embodiments, involves for example compressed air being provided, such as via an external compressed air source, in particular via an external compressed air network, an external compressed air canister or the like (not shown here), possibly with the fluidic interposition of a pneumatic pressure regulator R between the compressed air source and the receptacle 3. Instead of compressed air, however, there may fundamentally also be provision for a hydraulic pump, e.g. hose pump, for transporting the test medium M.

The respective data receiving instrument 18 in the form of the device 21 is, here, finally also designed to have the received sensor data, which are raw data here, read as experiment data by a separate data processing and/or evaluation device, for example an external computer (not shown here). By way of example, the data receiving instrument 18 shown in FIG. 1 can, after the recording of sensor data from one or more filtration experiments, possibly after preprocessing, for example in the form of smoothing and/or averaging of some or all sensor data, be sent in by the user to the manufacturer of the filtration experiment system 1 for evaluation. For this purpose, a data cable (not shown here) can be connected to the device 21, connecting the device 21 to the data processing and/or evaluation device or the computer. The data processing and/or evaluation device or the computer then detects the device 21 in particular as a drive that allows the stored sensor data to be copied, moved and/or erased. The data processing and/or evaluation device or the computer can then be used to select and/or dimension, according to predetermined scaling criteria, an applicable filter of a target system for the respective filter 6, 14 of the filtration experiment section 2.

In the exemplary embodiment in FIG. 2, the filtration experiment system 1 comprises two different data receiving instruments 18.

One data receiving instrument 18 is a control unit 22 that, besides the reception and possibly capture of sensor data, also permits processing of the sensor data, specifically, here, in such a way that the sensor data can be taken as a basis for controlling a pneumatic pressure regulator R between the compressed air source and the receptacle 3. In another exemplary embodiment, which is not shown here, a pump can also be controlled on the basis of the sensor data. In this case, the processing of the sensor data includes comparing the sensor data in each case with at least one setpoint value or setpoint value range, in particular for pressure sensor data and/or volume flow sensor data. The pressure of the compressed air is then regulated by way of the pneumatic pressure regulator R here in such a way that a predefined, constant or varying, pressure or volume flow of the test medium M and/or of the compressed air and/or of a wetting liquid B and/or of a flushing liquid is produced in the filtration experiment system 1, in particular in the filtration experiment section 2. In another exemplary embodiment, which is not shown here, the pump can also be regulated in such a way that a predefined, constant or varying, pressure or volume flow of the test medium M and/or of the compressed air and/or of a wetting liquid B and/or of a flushing liquid is produced in the filtration experiment system 1, in particular in the filtration experiment section 2.

The pneumatic pressure regulator R, which may be integrated in the control unit 22, can be used to cater for the “constant pressure” and “constant flow” experiment types, for example. In the case of the “constant pressure” experiment type, the pressure of the test medium M is kept at a constant value during the filtration experiment. In the case of the “constant flow” experiment type, the volume flow of the test medium M is kept at a constant value during the filtration experiment. Alternatively, this can also be achieved by way of a pneumatic pump, which is fluidically connected upstream of the receptacle 3, and possibly integrated in the control unit 22, or a hydraulic pump (not shown here), which is fluidically connected between the receptacle 3 and the filtration experiment section 2. In principle, experiment types with varying pressure for the test medium M and varying volume flow for the test medium M are also conceivable. Filtration experiments in which first the “constant pressure” experiment type and then the “constant flow” experiment type is performed, or vice versa, are also conceivable.

The data receiving instrument 18 in the form of the control unit 22 may, in principle, also be designed to automatically detect the experiment start of a filtration experiment and to automatically start control and/or to automatically detect the experiment end of a filtration experiment and to automatically end control. Here, however, there is provision for an external computer 26 that is connected to the data receiving instrument 18 or control unit 22 by way of a data cable 27 or a wireless connection and that can be used by the user to determine the start of the experiment and/or the end of the experiment.

The control unit 22 is, here, at a physical distance from the filtration experiment section 2 and the balance 20 and in particular also from a support 42 or stand 43, which will be described below, and can also be positioned independently thereof “At a physical distance” means that there is provision for a vertical and/or horizontal distance from the parts of the filtration experiment section 2, from the balance 20 and in particular also from the support 42 or stand 43.

The other data receiving instrument 18 in FIG. 2 is a device 23 that likewise allows processing of the sensor data besides the capture of sensor data, the processing of the sensor data here including bundling of sensor data to form data packets and sending of the data packets and/or conversion of analog sensor data into digital sensor data and/or, in particular prior to the conversion, amplification of the analog sensor signals.

The data receiving instrument 18 in the form of the device 23 is, here, also designed to automatically detect the configuration of the sensor arrangement 9, in particular the number of sensors 10, 11, 12 and/or the position of the sensors 10, 11, 12 on the device 23 and/or in the filtration section and/or the measurement principle of the sensors 10, 11, 12, and, in some embodiments, to carry out the above processing of the sensor data on the basis thereof.

The sensor data processed by the device 23 are then forwarded to the control unit 22.

The device 23 is, here, arranged adjacently to and along the filtration experiment section 2 and in mechanical contact with the sensors 10, that is to say in this respect not at a physical distance from the filtration experiment section 2. The device 23 is also in mechanical contact with the stand 43, that is to say in this respect not at a physical distance from the stand 43. The device 23 therefore also cannot be positioned independently of the filtration experiment section 2 and/or the stand 43.

In the exemplary embodiment in FIGS. 3 and 4, there is likewise provision for a data receiving instrument 18 in the form of the previously described control unit 22, which likewise allows processing of the sensor data for controlling an, in particular device-internal, pneumatic pressure regulator R besides the reception and possibly the capture of sensor data. Additionally or alternatively, the data receiving instrument 18 or control unit 22 can also allow the processing of the sensor data for controlling valves 8 of the valve arrangement 7 and/or an, in particular device-external, pump, for example a hydraulic pump for conveying the test medium M and/or a pneumatic pump 24 that produces compressed air for draining and cleaning the fluid line network 16 of the filtration experiment section 2. The terms “device external” and “device-internal” are always referenced to the control unit 22 here.

In the exemplary embodiment shown in FIGS. 3 and 4, the control unit 22 can control the valves 8 of the valve arrangement 7 and/or the pump, for example hydraulic pump and/or pneumatic pump 24, by way of a control cable 25, which is connected to the control unit 22.

The respective data receiving instrument 18 in the form of the control unit 22 is, here, finally also designed to transmit the received sensor data, which may be raw data or already processed sensor data, and/or the sensor data processed by the control unit 22 itself to a separate data processing and/or evaluation device, for example an external computer 26, as experiment data. For this purpose, there is provision for a data cable 27 or a wireless connection, each of which can connect the control unit 22 to the data processing and/or evaluation device or the computer 26. In this case too, the data processing and/or evaluation device or the computer 26 can be used to select and/or dimension, according to predetermined scaling criteria, an applicable filter of the target system for the respective filter 6, 14 of the filtration experiment section 2.

As already described above, one or more preassembly options, namely programming-related and/or circuit-related preassembly and/or fluidics-related preassembly and/or sensor-related preassembly, are conceivable for the filtration experiment system 1 as proposed. These preassembly options will be explained in more detail below.

As such, here, all the data receiving instruments 18 are preassembled on a programming-related and/or circuit-related basis concerning the reception of sensor data from the sensor arrangement 9. Here, the data receiving instrument 18 in the form of the device 21 shown in FIG. 1 is also preassembled on a programming-related and/or circuit-related basis concerning the capture of sensor data from the sensor arrangement 9. The data receiving instrument 18 in the form of the control unit 22 shown in FIGS. 2 and 3 is preassembled on a programming-related and/or circuit-related basis for the processing of sensor data from the sensor arrangement 9, here in such a way that the processing of the sensor data includes comparing the sensor data with at least one setpoint value or setpoint value range.

The data receiving instrument 18 in the form of the device 23 is likewise preassembled on a programming-related and/or circuit-related basis concerning the processing of sensor data from the sensor arrangement 9, here in such a way that the processing of the sensor data includes bundling sensor data to form data packets and sending the data packets, specifically to the control unit 22, and/or, if for example analog sensors 10, 11, 12 are involved, converting analog sensor data into digital sensor data and/or, in particular prior to the conversion, amplifying the analog sensor signals.

The data receiving instrument 18 shown in FIGS. 2 and 3 in the form of the control unit 22 is, here, also preassembled on a programming-related and/or circuit-related basis concerning the control of the pneumatic pressure regulator R and/or of the pump. In the exemplary embodiment shown in FIG. 2, the data receiving instrument 18 or control unit 22 is preassembled on a programming-related and/or circuit-related basis concerning the control of the pneumatic pressure regulator R integrated in the control unit 22. Additionally or alternatively, as in the exemplary embodiment shown in FIGS. 3 and 4, the data receiving instrument 18 or control unit 22 may be preassembled on a programming-related and/or circuit-related basis concerning the control of a pump, for example here the pneumatic pump 24 provided upstream of the control unit 22.

This preassembly means that the pneumatic pressure regulator R and/or the pump that is possibly present are, here, controllable as follows. As such, it can be possible to produce a predefined, constant or varying, pressure or volume flow of the test medium M in the filtration experiment section 2 and/or, in the exemplary embodiment shown in FIGS. 3 and 4, also a defined, constant or varying, pressure or volume flow of a wetting liquid B, in particular for an automatic filter wetting process, in the filtration experiment section 2. Additionally or alternatively, it is conceivable to be able to produce a defined, constant or varying, pressure or volume flow of the compressed air produced by the pump 24 and/or of a flushing liquid, in particular for an automatic draining and/or flushing process, in the filtration experiment section 2.

Additionally, here, the data receiving instrument 18 in the form of the control unit 22 according to the exemplary embodiment in FIG. 3 is preassembled on a programming-related and/or circuit-related basis concerning the control of one or more valves 8 of the valve arrangement 7. Here, there is provision for the preassembly in particular concerning the control of the respective valve 8 for a filter wetting process, for a filter venting process, for a filtration experiment with the test medium M and/or for a draining and/or flushing process.

The respective data receiving instrument 18 can be provided with a power supply 28 and/or at least one data interface 29, at least for receiving (data input 29a), possibly also for reading or outputting (data output 29b), sensor data. The data receiving instrument 18 in the form of the device 21 shown in FIG. 1 is, if it can be used to record sensor data, further in particular provided with a memory 30 for storing raw sensor data and/or processed sensor data. Such a memory 30 is optionally also provided for the data receiving instrument 18 in the form of the control unit 22 shown in FIGS. 2 and 3. The data receiving instrument 18 shown in FIGS. 2 and 3 in the form of the control unit 22 further comprises a pneumatic inlet 31 and at least one pneumatic outlet 32. In this case, as already explained previously, the control unit 22 in particular also has a pneumatic pressure regulator R integrated in it that connects the inlet 31 to the outlet 32 and, in some embodiments, produces a constant pressure or a pressure that brings about a constant volume flow, in order to route either the test medium M or the wetting liquid B through the filtration experiment section 2.

For all of the exemplary embodiments, it will be pointed out that the respective data receiving instrument 18 can be free of hydraulic connections. In particular, the respective data receiving instrument 18 here is also arrangeable at a physical distance from the filtration experiment section 2 and, at least in the case of the device 21 and/or the control unit 22, at a physical distance from the balance 20 and in particular also at a physical distance from a support 42 or stand 43, which will be described below.

There will now follow a brief discussion of options for the sensor-related and fluidics-related preassembly of the filtration experiment system.

There is provision for sensor-related preassembly, here, concerning the measurement principle, the specifications and/or the installation position of at least one sensor 10 of the sensor arrangement 9. According to the measurement principle, sensors are for example divided into pressure sensors, volume flow sensors and temperature sensors. “Specifications” means the technical and functional aspects, including in particular the dimensions, of the respective sensor 10. In the case of a sensor 10, the specifications for example also include the maximum measurement error, the standard measurement error, the temperature dependency, etc. The “installation position” denotes the respective position of the sensor 10 within the filtration experiment system 1, in particular within the filtration experiment section 2. Examples of the installation position are for example a point in front of or behind a specific other part of the filtration experiment section 2, in the case of a volume flow sensor or pressure sensor for example a point upstream of a filter 6, in particular a filter 6 for which the experiment data are ascertained.

There is provision for fluidics-related preassembly, here, concerning the operating principle, the specifications and/or the installation position of at least one filter 6, 14, 15 of the filter arrangement 13. According to the operating principle, filters are for example divided into liquid filters and air filters and/or into surface filters, depth filters, coated filters, etc. “Specifications” mean the technical and functional aspects, including in particular the dimensions, of the respective filter 6, 14, 15. For a filter 6, 14, 15, the specifications for example also include the filter medium (tissue, paper, nonwoven fabric, fibers, granules), the initial pressure loss, etc. The “installation position” denotes the respective position of the filter 6, 14, 15 within the filtration experiment system 1, in particular within the filtration experiment section 2. Examples of the installation position are for example a point in front of or behind a specific other part of the filtration experiment section 2, for example a point downstream of a sensor 10.

Alternatively or additionally, there is provision for fluidics-related preassembly, here, concerning the type of actuation, the specifications and/or the installation position of at least one valve 8 of the valve arrangement 7. According to the type of actuation, valves are for example divided into manually actuated, motor-actuated, magnetically actuated valves, etc. “Specifications” mean the technical and functional aspects, including in particular the dimensions, of the respective valve 8. For a valve 8, the specifications for example also include the type of sealing materials (hard/soft sealling), the position of the seal (on the piston/in the housing), the seal design, etc. The “installation position” denotes the respective position of the valve 8 within the filtration experiment system 1, in particular within the filtration experiment section 2. Examples of the installation position are for example a point in front of or behind a specific other part of the filtration experiment section 2, for example a point upstream or downstream of a filter 6.

Alternatively or additionally, there is provision for fluidics-related preassembly, here, concerning the specifications and/or the installation position of at least one line section 17 of the fluid line network 16. “Specifications” mean the technical and functional aspects, including in particular the dimensions, of the respective line section 17. For a line section 17, the specifications for example also include the type of material, the stiffness, the transparency, etc. The “installation position” denotes the respective position of the line section 17 within the filtration experiment system 1, in particular within the filtration experiment section 2. Examples of the installation position are for example a point in front of or behind a specific other part of the filtration experiment section 2, for example a point upstream or downstream of a filter 6.

A form of preassembly can result from the provision of assembly modules 33, that is to say from in particular manufacturer-preassembled units with multiple parts connected to one another as intended, in particular chosen from the group comprising the parts “sensor”, “filter”, “valve” and “line section”. Other parts of an assembly module 33 may be a receptacle 3 and/or a pump, in particular a hydraulic pump and/or a pneumatic pump 24, and/or, in particular in a housing 34, a circuit board 35.

Various assembly modules 33, which are enclosed by dashed frames in FIGS. 1 and 4 merely by way of illustration, are described below.

In principle, it is conceivable for at least one receptacle 3, at least one sensor 10 of the sensor arrangement 9 and/or at least one valve 8 of the valve arrangement 7, together with at least one line section 17 of the fluid line network 16, to form an assembly module 33 preassembled on a fluidics-related and/or sensor-related basis. Here, an assembly module 33 or multiple such assembly modules 33 form(s) the filtration experiment section 2.

As described previously, the respective assembly module 33 can also comprise the receptacle 3 for the test medium M and/or a receptacle 3 for wetting liquid (B) and/or flushing liquid.

FIG. 1 shows, as an example, an assembly module 33 comprising a receptacle 3 for the medium M, a volume flow sensor 10, 12 and a line section 17. It is also possible, as is likewise shown, according to another example, for the full ensemble comprising receptacle 3, volume flow sensor 10, 12, pressure sensor 10, 11 and applicable line sections 17 to form an assembly module 33. The respective sensor 10, 11, 12 may also already be connected to the respectively associated data cable, which is then likewise part of the respective assembly module 33.

Based on FIG. 1, the individual assembly modules 33 have no additional supporting structure. By contrast, each assembly module in FIG. 4 has provision for a supporting structure in the form of a housing 34 of the respective assembly module 33, here in the form of a plastic, resin, glass, ceramic and/or metal housing.

The housing 34 serves to hold at least one sensor 10 of the sensor arrangement 9, at least one filter 6, 14, 15 of the filter arrangement 13, at least one valve 8 of the valve arrangement 7 and/or at least one line section 17 of the fluid line network 16. The assembly module 33 then forms one block in each case, namely either a so-called connection block or a so-called expansion block or a so-called base block.

A connection block is, here, a physical unit having a housing 34, in or on which multiple parts required for setting up a filtration experiment section 2, e.g. one or more valves 8 and/or line sections 17, are installed so as to be able to function, although here this unit has no connection option for a filter 6, 14 for which experiment data are supposed to be ascertained. In the installed state, that is to say when the filtration experiment section is ready for use, this unit is used here solely to connect one or more pneumatic, hydraulic and/or electrical lines for appropriately supplying to all blocks that are fluidically connected downstream with reference to the direction of flow of the test medium M. That is to say that, in the installed state, the connection block is used to introduce the test medium M, possibly a wetting liquid B and/or flushing liquid and/or compressed air for draining the filters 6, 14 and line sections 17, into the full ensemble of all the blocks and/or to electrically connect the full ensemble of all the blocks. Here, “electrically connect” means that a supply of power and/or data transmission is made possible. Applicable interfaces mechanically, pneumatically, hydraulically and/or electrically connect the connection block in the installed state to the next block in each case, namely the base block or an expansion block, in order to route the test medium M, possibly the wetting liquid B and/or flushing liquid and/or the compressed air, to this next block, which then comprises a filter 6, 14 for which experiment data are supposed to be ascertained, and/or to electrically connect this next block.

The block(s) that are fluidically connected downstream of the connection block, that is to say at least the base block and possibly at least one expansion block, in some embodiments, have no such connection options that can be used to introduce the test medium M, possibly the wetting liquid B and/or flushing liquid and/or the compressed air for draining, into the full ensemble of all the blocks and/or to electrically connect the full ensemble of all the blocks.

A base block is, here, a physical unit that, in the installed state, is fluidically arranged at the end of the full ensemble comprising all the blocks and in particular at the end of the filtration experiment section 2 with reference to the direction of flow of the test medium M and accordingly comprises a fluid outlet 4a for discharging the filtered test medium F and/or the wetting liquid B and/or the flushing liquid from the full ensemble of all the blocks. Here, the base block additionally comprises a further fluid outlet 4b that is used for drawing off liquid residues when venting the filters 6, 14, when wetting the filters 6, 14 and/or when draining the filters 6, 14 and line sections 17. In principle, such a further fluid outlet 4b can also be dispensed with, however, in which case the fluid outlet 4a then performs the function thereof when venting, wetting and/or draining (not shown here). A base block is, here, a physical unit having a housing 34, in or on which multiple parts required for setting up a filtration experiment section 2, e.g. one or more valves 8, sensors 10 and/or line sections 17, are likewise installed so as to be able to function and to which a swappable filter 6, 14 for which experiment data are supposed to be ascertained can additionally be fluidically connected. Applicable interfaces mechanically, pneumatically, hydraulically and/or electrically connect the base block in the installed state to the block that is in each case fluidically connected upstream with reference to the direction of flow of the test medium M, namely the connection block or an expansion block, in order to receive the test medium M, possibly the wetting liquid B and/or flushing liquid and/or the compressed air, transferred from this block fluidically connected upstream and/or to electrically connect the base block.

The base block can additionally be a block, in particular the only block, that can be fixed to a support 42, in particular stand 43, which will be described below, in order to hold the overall structure of blocks in the installed state. In some embodiments, all the blocks are vertically stacked above one another in the installed state, the base block forming the lower end of the stack and supporting the other blocks. In another exemplary embodiment, which is not shown here, it is additionally or alternatively also possible for one or more other blocks, in particular the connection block and/or at least one expansion block, to be fixed to the support 42, in particular stand 43.

An expansion block is, here, a physical unit whose function essentially corresponds to that of a base block, with the difference that the expansion block is not fluidically arranged at the end of the full ensemble comprising all the blocks with reference to the direction of flow of the test medium M, but rather is always arranged in a region between a connection block and a base block, and also comprises no fluid outlet 4a for discharging the filtered test medium F and/or the wetting liquid B and/or the flushing liquid from the full ensemble of all the blocks and in particular also no fluid outlet 4b for drawing off liquid residues when venting, wetting and/or draining. An expansion block is, here, a physical unit having a housing 34, in or on which multiple parts required for setting up a filtration experiment section 2, e.g. one or more valves 8, sensors 10 and/or line sections 17, are likewise installed so as to be able to function and to which a swappable filter 6, 14 for which experiment data are supposed to be ascertained can also be fluidically connected.

Such an expansion block is configured in such a way that, if required for expanding the filtration experiment section 2, that is to say if experiment data are supposed to be ascertained for more than one filter 6, 14, multiple units or “blocks” that can be provided with a filter can be mechanically, pneumatically, hydraulically and/or electrically connected to one another by way of in each case at least one applicable interface. The interfaces mechanically, pneumatically, hydraulically and/or electrically connect an expansion block in the installed state to the block that is in each case fluidically connected upstream and downstream with reference to the direction of flow of the test medium M. It is thus possible to transfer the test medium M, possibly the wetting liquid B and/or flushing liquid and/or the compressed air, to the expansion block from the block that is fluidically connected upstream and/or to electrically connect the expansion block. Further, it is possible to route the test medium M and possibly the wetting liquid B and/or flushing liquid and/or the compressed air from the expansion block to the block that is fluidically connected downstream and/or to electrically connect the block that is fluidically connected downstream.

In principle, a filtration experiment section 2 can comprise one or more expansion blocks. In the exemplary embodiment shown in FIGS. 3 and 4, there is provision for two expansion blocks by way of illustration. The full ensemble comprising one or more expansion blocks is fundamentally enclosed by the other two block types. As such, the full ensemble comprising one or more expansion blocks has a connection block fluidically connected upstream and a base block fluidically connected downstream with reference to the direction of flow of the test medium M. A filtration experiment section 2 can also be constructed without an expansion block, however.

In the exemplary embodiment shown in FIGS. 3 and 4, the situation is now that the two middle assembly modules 33 (expansion blocks) have at least one sensor 10, valve 8 and/or line section 17 arranged inside the housing 34 and/or at least one filter 6, 14 arranged, in particular detachably, outside the housing 34. The filter 6, 14 is thus accessible without dismantling the housing 34 or the expansion block. It is possible to swap a filter in particular without setting up and taking down the entire system.

In the exemplary embodiment in FIGS. 3 and 4, the situation is further that an assembly module 33 (base block), which is arranged right at the bottom here, comprises no further interfaces and/or outlets downstream, that is to say toward the bottom, with the exception of the fluid outlet 4a for discharging the filtered test medium F and/or the wetting liquid B and/or the flushing liquid and with the exception of the fluid outlet 4b, which is likewise provided here, for drawing off liquid residues when venting, wetting and/or draining. Otherwise, the base block can be of the same design as an expansion block.

Further, there is provision in this exemplary embodiment for an assembly module 33, which is arranged right at the top here, to be free of filters (connection block). The connection block also differs from the other two block types, here, in as much as it contains a pump, here a pneumatic pump 24, that can be used to produce the compressed air for draining the blocks.

Furthermore, all the assembly modules 33 here comprise, in particular in the housing 34, electronics having at least one electrical circuit board 35, in particular a circuit board 35 having an integrated circuit, that is used to receive sensor data and/or to control at least one of the valves 8 and/or the respective pump, in particular the hydraulic pump and/or pneumatic pump 24. The control electronics formed by the electronics or the circuit boards 35 and possibly the control unit 22, in some embodiments, form a logical abstraction level for the filtration experiment system 1, which means that for example multiple valves 8 do not have to appear or be addressed as individual actuators in the system, but rather can be addressed jointly as a unit. It is then possible for example for a command “drain base block” to be transmitted from the control unit 22. The electronics or circuit board 35 in the base block resolve(s) the command and control(s) the necessary valves 8 in the individual block.

Additionally, the electronics of a block in particular contain the power electronics required for the valves 8 of this block.

In particular, the respective electrical circuit board 35 can also be used to convert analog sensor data into digital sensor data and/or, in particular prior to the conversion, to amplify the analog sensor signals.

Here, there is furthermore provision, as FIG. 4 shows, for every assembly module 33 on which a filter 6, 14 is arrangeable or arranged, in particular every housing 34 to or in which a filter 6, 14 is attachable or attached, to have precisely one associated filter 6, 14.

Here, the respective assembly module 33, in particular the housing 34, comprises at least one pneumatic interface 36, at least one hydraulic interface 37 and/or at least one electrical interface 38. In some embodiments, each pair of assembly modules 33, in particular each pair of housings 34, is directly mechanically connectable or connected to one another and in particular vertically stackable or stacked above one another.

Here, mechanical connection, in particular direct mechanical connection, of two assembly modules 33 to one another forms at least one pneumatic connection 39, at least one hydraulic connection 40 and/or at least one electrical connection 41 between the assembly modules 33 by connecting each pair of mutually corresponding interfaces 36, 37, 38.

The exemplary embodiment in FIGS. 3 and 4 is used below to provide a brief description of the various phases with applicable valve switching positions, which the data receiving instrument 18 in the form of the control unit 22 passes through fully automatically here as part of a filtration experiment, after the filter(s) 6, 14 for which experiment data are supposed to be produced has(have) been installed and connected. The automation of the sequence ensures constant quality and comparable timing for the filter preparation.

In principle, all the filters 6, 14 of the individual blocks, here individually in sequence vertically from top to bottom, that is to say starting at the filter 6, 14 on the upper expansion block, followed by the filter 6, 14 on the lower expansion block, through to the filter 6, 14 on the base block, are vented and wetted, then drained and then filled with the test medium M, wherein venting takes place again. Next, the actual filtration experiment then takes place. Finally, the line sections 17 through which the test medium M has previously flowed are drained again so that no liquid can escape from the respective block during a change of filter.

The aforementioned steps will now be described in detail below by way of illustration for the upper expansion block. These steps are carried out accordingly for the other blocks.

In this case, reference is made to the valves 8, denoted by “a” to “e” in FIG. 4, which are configured as 3-way valves here, namely:

the valve 8 denoted by “a” of the connection block, which valve comprises a connection for a line section leading to the receptacle 3 that contains test medium M, a connection for a line section leading to the receptacle 3 that contains wetting liquid B, here water, and a connection for a line section leading to the valve 8 denoted by “b”,

the valve 8 denoted by “b” of the connection block, which valve comprises a connection for the line section leading to the valve “a”, a connection for a line section leading to a compressed air source, here pneumatic pump 24, and a connection for a line section, used for transferring the test medium M, leading to the next filter 6, 14 in the upper expansion block,

the valve 8 denoted by “c” of the upper expansion block, which valve comprises a connection for a line section, used for venting, leading away from the filter 6, 14, a connection for a line section of a drain line that leads to the fluid outlet 4a and/or fluid outlet 4b and is used to draw off liquid residues when venting, wetting and/or draining, and a connection for a line section that has no function here and is connectable to a further line section of the drain line in an upstream expansion block, which is not provided here,

the valve 8 denoted by “d” of the upper expansion block, which valve comprises a connection for a line section, used for drawing off the test medium M, leading away from the filter 6, 14, a connection for a line section leading to the compressed air source and a connection for a line section leading to the valve 8 denoted by “e”, and

the valve 8 denoted by “e” of the upper expansion block, which valve comprises a connection for the line section leading to the valve “d”, a connection for a line section, used for transferring the test medium M, leading to the next filter 6, 14 of the lower expansion block and a connection for a line section that leads to the drain line.

The valves 8 denoted by “c” to “e” here have the same function in the expansion blocks and in the base block, but there is provision in the base block for a line section to the fluid outlet 4a instead of a line section to a further filter 6, 14.

The fully automatic sequence is now described by way of illustration for the upper expansion block, this sequence being, at least essentially, the same for the lower expansion block and the base block.

Specifically, the filter 6, 14 of the upper expansion block is now first filled in each case with the wetting liquid B, for example water here, and vented in the process. For this purpose, the valve “a” is closed toward the receptacle 3 that contains test medium M, open toward the receptacle 3 that contains wetting liquid B and open toward the valve “b”. Further, the valve “b” is open toward the valve “a”, closed toward the compressed air source and open toward the next filter 6, 14 of the upper expansion block. Further, the valve “c” is open toward the filter 6, 14 of the upper expansion block, open toward the fluid outlet 4a and/or fluid outlet 4b and closed toward the, here functionless, line section of the drain line. Further, the valve “d” is open toward the filter 6, 14, closed toward the compressed air source and open toward the valve “e”. Finally, the valve “e” is open toward the valve “d”, closed toward the next filter 6, 14 of the lower expansion block and open toward the drain line or, via the latter, toward the fluid outlet 4a and/or fluid outlet 4b. Wetting liquid B is now pumped through the filter 6, 14 and the applicable line sections and taken away through the respective fluid outlet, here the fluid outlet 4b, via the drain line, here without being routed through the next filter 6, 14 in the process. The valve “e” of the base block is in particular closed toward the fluid outlet 4a and toward the valve “d”.

The filter 6, 14 of the upper expansion block is then wetted, also with water here, after the venting has been carried out for all the filters 6, 14. For this purpose, the valve “a” is closed toward the receptacle 3 that contains test medium M, open toward the receptacle 3 that contains wetting liquid B and open toward the valve “b”. Further, the valve “b” is open toward the valve “a”, closed toward the compressed air source and open toward the next filter 6, 14 of the upper expansion block. Further, the valve “c” is closed toward the filter 6, 14 of the upper expansion block. Further, the valve “d” is open toward the filter 6, 14, closed toward the compressed air source and open toward the valve “e”. Finally, the valve “e” is open toward the valve “d”, closed toward the next filter 6, 14 of the lower expansion block and open toward the drain line or, via the latter, toward the fluid outlet 4a and/or fluid outlet 4b. Wetting liquid B is now pumped through the filter 6, 14 and the applicable line sections and taken away through the respective fluid outlet, here the fluid outlet 4b, via the drain line, here without being routed through the next filter 6, 14 in the process. The valve “e” of the base block is in particular closed toward the fluid outlet 4a and toward the valve “d”.

The filter 6, 14 of the upper expansion block is then drained, after the wetting has been carried out for all the filters 6, 14, those line sections 17 of the fluid line network 16 through which the test medium M later flows also being emptied in order to prevent dilution of the test medium M. For this purpose, the valve “a” is closed toward the receptacle 3 that contains test medium M and toward the receptacle 3 that contains wetting liquid B. Further, the valve “b” is open toward the compressed air source and toward the next filter 6, 14 of the upper expansion block. Further, the valve “c” is open toward the filter 6, 14 of the upper expansion block, open toward the fluid outlet 4a and/or fluid outlet 4b and closed toward the, here functionless, line section of the drain line. Further, the valve “d” is open toward the filter 6, 14, closed toward the compressed air source and open toward the valve “e”. Finally, the valve “e” is open toward the valve “d”, open toward the next filter 6, 14 of the lower expansion block and closed toward the drain line or, via the latter, toward the fluid outlet 4a and/or fluid outlet 4b. The compressed air source is now used to transport compressed air through the filter 6, 14 and the applicable line sections, and residues of the wetting liquid B are taken away through the respective fluid outlet, here the fluid outlet 4b, via the drain line. The valve “e” of the base block is in particular closed toward the fluid outlet 4a and toward the valve “d”.

The “draining” procedure is finally also carried out in the same way first for the filter 6, 14 of the lower expansion block and then for the filter 6, 14 of the base block. Here too, the block whose filter 6, 14 is now being drained has, in each case, the valve “c” open toward the filter 6, 14, open toward the fluid outlet 4a and/or fluid outlet 4b and closed toward the line section of the drain line that leads to the block fluidically connected upstream in each case. Further, the block fluidically connected upstream has, in each case, the valve “d” closed toward the filter 6, 14, open toward the compressed air source and open toward the valve “e”. Further, the block whose filter 6, 14 is now being drained has, in each case, the valve “d” open toward the filter 6, 14, closed toward the compressed air source and open toward the valve “e”. Finally, the block whose filter 6, 14 is now being drained has, in each case, the valve “e” open toward the valve “d”. In the case of the lower expansion block, the valve “e” is additionally open toward the next filter 6, 14 of the base block and closed toward the drain line or, by the latter, toward the fluid outlet 4a and/or fluid outlet 4b. In the case of the base block, the valve “e” here is open toward the fluid outlet 4b and in particular closed toward the fluid outlet 4a.

The filter 6, 14 of the upper expansion block is then filled with the test medium M, and vented in the process, after the draining has been carried out for all the filters 6, 14 and line sections 17. For this purpose, the valve “a” is open toward the receptacle 3 that contains test medium M, closed toward the receptacle 3 that contains wetting liquid B and open toward the valve “b”. Further, the valve “b” is open toward the valve “a”, closed toward the compressed air source and open toward the next filter 6, 14 of the upper expansion block. Further, the valve “c” is open toward the filter 6, 14 of the upper expansion block, open toward the fluid outlet 4a and/or fluid outlet 4b and closed toward the, here functionless, line section of the drain line. Further, the valve “d” is open toward the filter 6, 14, closed toward the compressed air source and open toward the valve “e”. Finally, the valve “e” is open toward the valve “d”, closed toward the next filter 6, 14 of the lower expansion block and open toward the drain line or, via the latter, toward the fluid outlet 4a and/or fluid outlet 4b. Test medium M is now pumped through the filter 6, 14 and the applicable line sections and taken away through the respective fluid outlet, here the fluid outlet 4b, via the drain line, without being routed through the next filter 6, 14 in the process. The valve “e” of the base block is in particular closed toward the fluid outlet 4a and toward the valve “d”.

The valve “c” is then closed toward the filter 6, 14 of the upper expansion block after the filter 6, 14 of the upper expansion block has been filled with the test medium M and vented in the process. Test medium M continues to be pumped through the filter 6, 14 and the applicable line sections and taken away through the respective fluid outlet, here the fluid outlet 4b, via the drain line. The valve “e” is then opened toward the filter 6, 14 of the lower expansion block and closed toward the drain line or, via the latter, toward the fluid outlet 4a and/or fluid outlet 4b, in order to fill and vent this filter 6, 14. After said filter has been vented, the valve “c” in the lower expansion block is also closed toward the filter 6, 14, wherein test medium M continues to be pumped through the filter 6, 14 of the applicable line sections and taken away through the respective fluid outlet, here the fluid outlet 4b, via the drain line. The “filling and venting” procedure is finally also carried out in the same way for the base block. Here too, the valve “c” is closed toward the filter 6, 14, wherein test medium M continues to be pumped through the filter 6, 14 and the applicable line sections and taken away through the respective fluid outlet, here the fluid outlet 4b, via the drain line. The valve “e” of the base block is in particular closed toward the fluid outlet 4a.

Now the actual filtration experiment takes place. For this purpose, the valve “a” is open toward the receptacle 3 that contains test medium M, closed toward the receptacle 3 that contains wetting liquid B and open toward the valve “b”. Further, the valve “b” is open toward the valve “a”, closed toward the compressed air source and open toward the next filter 6, 14 of the upper expansion block. Further, the valve “c” is closed toward the filter 6, 14 of the upper expansion block. Further, the valve “d” is open toward the filter 6, 14, closed toward the compressed air source and open toward the valve “e”. Finally, the valve “e” is open toward the valve “d”, open toward the next filter 6, 14 of the lower expansion block and closed toward the drain line or, via the latter, toward the fluid outlet 4a and/or fluid outlet 4b. The same switching position is also possessed by the valves “c” to “e”, having the same function, in the lower expansion block and in the base block. Test medium M is now pumped through the filters 6, 14 and the applicable line sections and taken away through the fluid outlet 4a. The valve “e” of the base block is closed toward the fluid outlet 4b here.

After the filtration experiment has ended, the filter 6, 14 of the upper expansion block and then accordingly also individually the further filters 6, 14 are finally drained. For the purpose of draining the filter 6, 14 of the upper expansion block, the valve “a” is closed toward the receptacle 3 that contains test medium M and toward the receptacle 3 that contains wetting liquid B. Further, the valve “b” is open toward the compressed air source and toward the next filter 6, 14 of the upper expansion block. Further, the valve “c” is open toward the filter 6, 14 of the upper expansion block, open toward the fluid outlet 4a and/or fluid outlet 4b and closed toward the, here functionless, line section of the drain line. Further, the valve “d” is open toward the filter 6, 14, closed toward the compressed air source and open toward the valve “e”. Finally, the valve “e” is open toward the valve “d”, open toward the next filter 6, 14 of the upper expansion block and closed toward the drain line or, via the latter, toward the fluid outlet 4a and/or fluid outlet 4b. The compressed air source is now used to transport compressed air through the filter 6, 14 and the applicable line sections, and residues of the test medium M are taken away through the respective fluid outlet, here the fluid outlet 4b, via the drain line. The valve “e” of the base block is in particular closed toward the fluid outlet 4a in this case.

The “draining” procedure is finally also, as has already been described previously for the draining after the wetting, carried out first for the filter 6, 14 of the lower expansion block and then for the filter 6, 14 of the base block. After the draining has been carried out for all the filters 6, 14, the filters 6, 14 can be removed.

Next, the above sequence can be carried out again in the same way with new filters 6, 14.

Alternatively, the filtration experiment section 2 can be cleaned. This is accomplished by using empty tubes instead of the filters 6, 14. In principle, in an embodiment that is not shown here, the same steps as for the venting and subsequent wetting can then be carried out, but using a cleaning liquid instead of the wetting liquid B. However, here, in contrast to the venting described previously, the valve “d” is not closed, but rather open, toward the compressed air source and in particular the valve “d” is not open, rather closed, toward the filter 6, 14.

Here, there is further provision for the filtration experiment system 1 to comprise at least one support 42. Such a support can be used in different ways. Based on FIG. 1, only the receptacle 3, in particular the receptacle 3 for the test medium M, is fixable or fixed to the support 42. Based on FIG. 2, a plate-like, first support 42 has only one or more sensors 10, 11, 12 of the sensor arrangement 9 fixable or fixed to it and a bar-like, further support 42 has the receptacle 3, in particular the receptacle 3 for the test medium M, fixable or fixed to it. Based on FIGS. 3 and 4, one or more assembly modules 33 and two receptacles 3, in particular the receptacle 3 for the test medium M and the receptacle 3 for the wetting liquid B and/or flushing liquid, are each fixable or fixed to the common support 42.

The support 42 is for example a stand 43 having an, in particular adjustable-height, holder 44, as shown in the exemplary embodiments in FIG. 1 and in FIGS. 3 and 4.

However, it is also conceivable, as shown in FIG. 2, for the support 42 to be a mounting plate 45, can be made of metal, that is in particular attached to a stand 43 and to which multiple sensors 10, 11, 12 of the sensor arrangement 9 are each, in particular detachably, fixable or fixed. In some embodiments, the sensors 10, 11, 12 are fixed to the mounting plate 45 magnetically, with a form-fit and/or with a force-fit. In some embodiments, the sensors 10, which are pressure sensors 11 here, comprise an attachment section 46 that can comprise a magnet 47. Alternatively or additionally, the attachment section 46 may also comprise a plug-in or clamping element that interacts with a corresponding mating piece on the mounting plate 45 with a form-fit and/or with a force-fit.

Such a design has the advantage that the unit comprising the mounting plate 45 and parts of the filtration experiment section 2 that are attached thereto is attachable and adjustable in height independently of the respective receptacle 3. The height of the filtration experiment system 1 can therefore be minimized.

The sensors 10, 11, 12 are, here, designed as modules preassembled for mounting on the mounting plate 45, said modules comprising not only the attachment section 46 but also a flow channel for the test medium M, which flow channel is used for pressure measurement here, and a bracket for the filter(s) 6, 14. In the mounted state, each pair of sensors 10, 11, 12 fixed to the mounting plate 45 holds one filter 6, 14 between them, said filter itself not being fixed to the mounting plate 45. It will be emphasized that in another exemplary embodiment, which is not shown here, there may fundamentally also be provision for volume flow sensors 12 on such a mounting plate 45 in the same way.

The mounting plate 45 is, here, part of a housing of a data receiving instrument 18, 23 (sensor hub), in particular of the data receiving instrument 18, 23, that is designed to carry out bundling of the sensor data to form data packets and sending of the data packets and/or conversion of analog sensor data into digital sensor data and/or, in particular prior to the conversion, amplification of the analog sensor signals as processing of the sensor data. The bundling of the sensor data to form data packets results in there being, here, only a single data cable 27 for transmitting sensor data to the control unit 22. Another advantage is that, in the case of analog sensors 10, 11, 12, the data cables from the sensor 10, 11, 12 to the digitizing circuit can be short and are therefore less susceptible to interference.

Further, here, the data interfaces 29 provided are multiple data inputs 29a for the sensors 10, 11, 12 and at least one data output 29b for the data cable 27 for transmitting the sensor data to the control unit 22, at the sensor hub 23. In some embodiments, the number of data outputs 29b is less than the number of data inputs 29a. Here, there is provision for only a single data output 29b.

As FIG. 2 shows, the data inputs 29a may be arranged on the mounting plate 45 or the housing of the sensor hub 23 in a row, here vertically from top to bottom. In some embodiments, this then also predefines the order of the connected sensors 10, 11, 12 in the filtration experiment section 2. A sensor 10, 11, 12 connected to a data input 29a in a higher position needs to be positioned further forward in the filtration experiment section 2, for example. The sensor hub 23 can in particular label the sensor data with the position of the data input 29a, as a result of which the control unit 22 is able to process and/or record the received sensor data in the correct order.

The sensor hub 23 is in particular designed in such a way that the sole direction of data flow runs from the sensors 10, 11, 12 via the sensor hub 23 to the control unit 22.

In the exemplary embodiments in FIGS. 2 to 4, the situation is finally further that the respective support 42 and/or the respective stand 43 are/is mechanically connected to the housing of a balance 20 of the weighing arrangement 19. The balance 20 can be used during a filtration experiment to determine the weight of the filtrate F in the collecting container 5 over time and, from that, the volume flow in the filtration experiment section 2. In principle, it is also possible to use a volume flow sensor 10, 12 as in FIG. 1, however, in which case a balance can be dispensed with. An advantage of such a balance 20 is also that it is relatively heavy and therefore forms a good base for the support 42 and/or the stand 43. This reduces the number of parts and the overall weight of the filtration experiment system 1 to be transported when a balance 20 is used. A balance 20 also has the advantage that it can function as a volume flow sensor largely independently of the viscosity of the liquid. “Correct” volume flow sensors are typically sensitive to viscosity, or permit operation only with aqueous solutions.

In accordance with another teaching, which is assigned independent significance, a data receiving instrument 18, 21, 22, 23 for use in a bioprocessing, in particular biopharmaceutical, filtration experiment system 1 for filtering a liquid test medium M as part of a filtration experiment in a filtration experiment section 2 of the filtration experiment system 1, which filtration experiment section runs from a receptacle 3 for holding the test medium to be filtered M to a fluid outlet 4 for the filtered test medium F, is provided, wherein the data receiving instrument 18, 21, 22, 23 is designed to receive, in particular also to capture and/or process, sensor data, produced as part of the filtration experiment, from a sensor arrangement 9 as experiment data for at least one filter 6, said experiment data being able to be taken as a basis for selecting and/or dimensioning the filter of a target system according to predetermined scaling criteria. In this respect, reference can be made to the explanations pertaining to the bioprocessing filtration experiment system as proposed.

The essential aspect in this case is that the data receiving instrument 18, 21, 22, 23 is preassembled on a programming-related and/or circuit-related basis concerning the reception of sensor data from the sensor arrangement 9.

In accordance with some embodiments, the use of a packed filtration experiment set comprising preassembled system components for setting up a bioprocessing, in particular biopharmaceutical, filtration experiment system 1 as proposed is provided. In this respect, reference can be made to the explanations pertaining to the bioprocessing filtration experiment system as proposed.

The essential aspect in this case is that the filtration experiment set in the pack comprises at least one assembly module 33 comprising at least one line section 17 of the fluid line network 16, which line section is connected to at least one sensor 10, 11, 12 of the sensor arrangement 9 and/or to at least one valve 8 of the valve arrangement 7 as intended. In an embodiment that is not shown here, it is fundamentally also possible for at least one filter 6, 14, 15 of the filter arrangement 13 to be contained in the pack. There may also be provision for a receptacle 3, which can be fluidically connected to the line section 17, as part of the assembly module 33.

1. A bioprocessing filtration experiment system for filtering a liquid test medium as part of a filtration experiment in a filtration experiment section of the filtration experiment system, which filtration experiment section runs from a receptacle for holding the test medium to be filtered to a fluid outlet for the filtered test medium, wherein the filtration experiment system is designed to ascertain, as part of the filtration experiment, sensor data as experiment data for at least one filter, said experiment data being able to be taken as a basis for selecting and/or dimensioning the filter of a target system according to predetermined scaling criteria,
wherein the filtration experiment system is preassembled on an at least partially programming-related and/or circuit-related, at least partially fluidics-related and/or at least partially sensor-related basis.

2. The bioprocessing filtration experiment system as claimed in claim 1, wherein the filtration experiment system, comprises a valve arrangement containing one or more valves, a sensor arrangement containing one or more sensors, volume flow sensors and/or temperature sensors, a filter arrangement containing one or more filters, and/or a fluid line network containing multiple line sections via which the test medium reaches the respective filter, and/or
wherein the filtration experiment system comprises at least one data receiving instrument for receiving sensor data from the sensor arrangement and/or comprises a weighing arrangement containing a balance.

3. The bioprocessing filtration experiment system as claimed in claim 1, wherein at least one data receiving instrument is preassembled on a programming-related and/or circuit-related basis concerning the reception of sensor data from the sensor arrangement, and/or
wherein at least one data receiving instrument is preassembled on a programming-related and/or circuit-related basis concerning the capture and/or processing of sensor data from the sensor arrangement.

4. The bioprocessing filtration experiment system as claimed in claim 1, wherein the filtration experiment system comprises at least one pump, and/or at least one pneumatic pressure regulator and wherein at least one data receiving instrument is preassembled on a programming-related and/or circuit-related basis concerning the control of the pump and/or of the pneumatic pressure regulator.

5. The bioprocessing filtration experiment system as claimed in claim 1, wherein at least one data receiving instrument is preassembled on a programming-related and/or circuit-related basis concerning the control of at least one valve of the valve arrangement for a filter venting process, for a filtration experiment with the test medium and/or for a draining and/or flushing process.

6. The bioprocessing filtration experiment system as claimed in claim 1, wherein the at least one data receiving instrument comprises a power supply, at least one data interface, a memory for storing raw sensor data and/or processed sensor data, a pneumatic inlet, at least one pneumatic outlet, a pneumatic pressure regulator and/or at least one pneumatic pump.

7. The bioprocessing filtration experiment system as claimed in claim 1, wherein the filtration experiment system is preassembled on a sensor-related basis concerning the measurement principle, the specifications and/or the installation position of at least one sensor of the sensor arrangement, and/or
wherein the filtration experiment system is preassembled on a fluidics-related basis concerning the operating principle, the specifications and/or the installation position of at least one filter of the filter arrangement, and/or
wherein the filtration experiment system is preassembled on a fluidics-related basis concerning the type of actuation, the specifications and/or the installation position of at least one valve of the valve arrangement, and/or
wherein the filtration experiment system is preassembled on a fluidics-related basis concerning the specifications and/or the installation position of at least one line section of the fluid line network.

8. The bioprocessing filtration experiment system as claimed in claim 1, wherein at least one sensor of the sensor arrangement, at least one filter of the filter arrangement, at least one valve of the valve arrangement and/or at least one receptacle together with at least one line section of the fluid line network form an assembly module preassembled on a fluidics-related and/or sensor-related basis, the assembly module or multiple such assembly modules.

9. The bioprocessing filtration experiment system as claimed in claim 1, wherein the respective assembly module comprises a housing for holding at least one sensor of the sensor arrangement, at least one filter of the filter arrangement, at least one valve of the valve arrangement and/or at least one line section of the fluid line network.

10. The bioprocessing filtration experiment system as claimed in claim 1, wherein an assembly module is free of filters and/or comprises electronics having at least one electrical circuit board for receiving sensor data and/or for controlling at least one valve and/or for controlling a pump and/or
wherein an assembly module comprises a pump.

11. The bioprocessing filtration experiment system as claimed in claim 1, wherein every assembly module on which a filter is arrangeable or arranged has precisely one associated filter.

12. The bioprocessing filtration experiment system as claimed in claim 1, wherein the respective assembly module comprises at least one pneumatic interface, at least one hydraulic interface and/or at least one electrical interface.

13. The bioprocessing filtration experiment system as claimed in claim 1, wherein a mechanical connection of two assembly modules to one another forms at least one pneumatic connection, at least one hydraulic connection and/or at least one electrical connection between the assembly modules by way of each pair of mutually corresponding interfaces.

14. The bioprocessing filtration experiment system as claimed in claim 1, wherein the filtration experiment system has a support and wherein only one receptacle is fixable or fixed to the support and/or only one or more sensors of the sensor arrangement are each fixable or fixed to the common support and/or only one or more assembly modules are each fixable or fixed to the common support.

15. The bioprocessing filtration experiment system as claimed in claim 1, wherein in the mounted state, each pair of sensors fixed to the mounting plate has a filter arranged between them that is itself not fixed to the mounting plate.

16. The bioprocessing filtration experiment system as claimed in claim 1, wherein the mounting plate part of a housing of a data receiving instrument.

17. The bioprocessing filtration experiment system as claimed in claim 1, wherein the respective support and/or the respective stand is mechanically connected to the housing of a balance of the weighing arrangement.

18. A data receiving instrument for use in a bioprocessing filtration experiment system for filtering a liquid test medium as part of a filtration experiment in a filtration experiment section of the filtration experiment system, which filtration experiment section runs from a receptacle for holding the test medium to be filtered to a fluid outlet for the filtered test medium wherein the data receiving instrument is designed to receive from a sensor arrangement as experiment data for at least one filter, said experiment data being able to be taken as a basis for selecting and/or dimensioning the filter of a target system according to predetermined scaling criteria, wherein the data receiving instrument is preassembled on a programming-related and/or circuit-related basis concerning the reception of sensor data from the sensor arrangement.

19. The data receiving instrument as claimed in claim 18, wherein the data receiving instrument is designed to automatically detect the experiment start of a filtration experiment and to automatically start the recording of the sensor data and/or to automatically detect the experiment end of a filtration experiment and to automatically end the recording of the sensor data.

20. The use of a packed filtration experiment set comprising preassembled system components for setting up a bioprocessing filtration experiment system as claimed in claim 1,
wherein the filtration experiment set in the pack comprises at least one assembly module comprising at least one line section of the fluid line network, which line section is connected to at least one sensor of the sensor arrangement, to at least one filter of the filter arrangement and/or to at least one valve of the valve arrangement as intended.
